(19) United States
(12) Patent Application Publication
(10) Pub. No.: US 2012/0300628 A1
(43) Pub. Date: Nov. 29, 2012

(54) METHOD AND APPARATUS TO PASSIVELY DETERMINE THE STATE OF A FLOW INCLUDING DETERMINING FLOW STATE IN THE EVENT OF MISSING DATA ON ONE OR BOTH SIDES OF THE FLOW

(76) Inventors: Dan Prescott, Elbert, CO (US); Sean O'Brien, Colorado Springs, CO (US); Jim Kisela, Snohomish, WA (US); Shawn McManus, Colorado Springs, CO (US)

(21) Appl. No.: 13/116,704

(22) Filed: May 26, 2011

(51) Int. Cl. H04L 12/26; H04L 12/56

(52) U.S. Cl. 370/232; 370/253

(57) ABSTRACT

A method and apparatus is disclosed herein for determining the state of a flow of packets in a network. In one embodiment, the method comprises: monitoring, using a monitoring device, a flow of packets that are part of a connection between two network devices in a network, where the monitoring device is located in the network at one side of the connection; and passively determining a state of the flow while monitoring the flow, including determining at least one state of the flow without receiving data in the flow of packets that specifies the flow is in the at least one state.

### FIELD OF THE INVENTION

The present invention relates to the field of monitoring of network traffic; more particularly, the present invention relates to determining state of a flow of packets when data specifying such state is missing from the flow of packets.

### BACKGROUND OF THE INVENTION

Networks can include multiple network devices such as routers, switches, hubs, servers, client computers (e.g., desktop PCs, laptops, workstations), and peripheral devices networked together across a local area network (LAN) and/or a wide area network (WAN). In such networks, data is typically exchanged between a requesting device, such as a client, and a responding device, such as a server. These data exchanges may involve large amounts of traffic.

The traffic is typically transmitted in data packet networks in flows. A flow consists of the packets that make up a connection between two network devices (e.g., between a client and a server) in the network and include any packet that constitutes the instantiation or destruction of the connection.

Today, network technicians may want to analyze network traffic. Because the computer networking environments are very complex and the amount of data exchanged is very large, the network technician may be interested in analyzing only selected traffic between clients and servers, and in particular situations only between specific client/server sets. Such analysis is often done using network monitoring and analyzing devices that are positioned in the network near one or both of the client and the server. Using the monitoring device, the network traffic may be observed and a determination may be made as to the client, the server and the protocol, and if the observed traffic is of the desired type and represents client/server traffic within a group of interest to the technician, the traffic or information about the traffic is passed on for further processing or analysis.

### SUMMARY OF THE INVENTION

A method and apparatus is disclosed herein for determining the state of a flow of packets in a network. In one embodiment, the method comprises: monitoring, using a monitoring device, a flow of packets that are part of a connection between two network devices in a network, where the monitoring device is located in the network at one side of the connection; and passively determining a state of the flow while monitoring the flow, including determining at least one state of the flow without receiving data in the flow of packets that specifies the flow is in the at least one state.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a network.

FIG. 2 is a flow diagram of one embodiment of a monitoring process.

FIG. 3 is a flow diagram of one embodiment of a process for processing a packet as part of the monitoring process.

FIG. 4 illustrates one embodiment of a block diagram of a network monitoring device.

### DETAILED DESCRIPTION OF THE PRESENT INVENTION

Embodiments of the present invention passively determine the current state of a flow of packets (e.g., a TCP flow) in a network while monitoring the flow in the network. In one embodiment, the flow is monitored from one side (e.g., server side, client side) of a network connection. However, the monitoring could be monitored at both sides of the network connection. The monitoring and flow state determination is performed by a network device (e.g., a network monitoring and analysis device).

In one embodiment, determining the state of the flow includes determining that data is missing at one or both sides of the flow. For example, the monitoring device monitors the flow and determines the flow has been closed even though a packet in the flow indicating the flow was closed had not been received. In one embodiment, using this determination, the monitoring system closes and opens flow records in the event the monitoring system was not provided the packets in which the end points of the connection may have closed and re-opened the connection.

In one embodiment, the monitoring system stores the state information of all flows being monitored in memory to maintain an accurate and deterministic view of existing flows. That is, the monitoring system stores a record of each flow and its associated state. The state information can be used to either age, close, or open these flows as needed.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### OVERVIEW

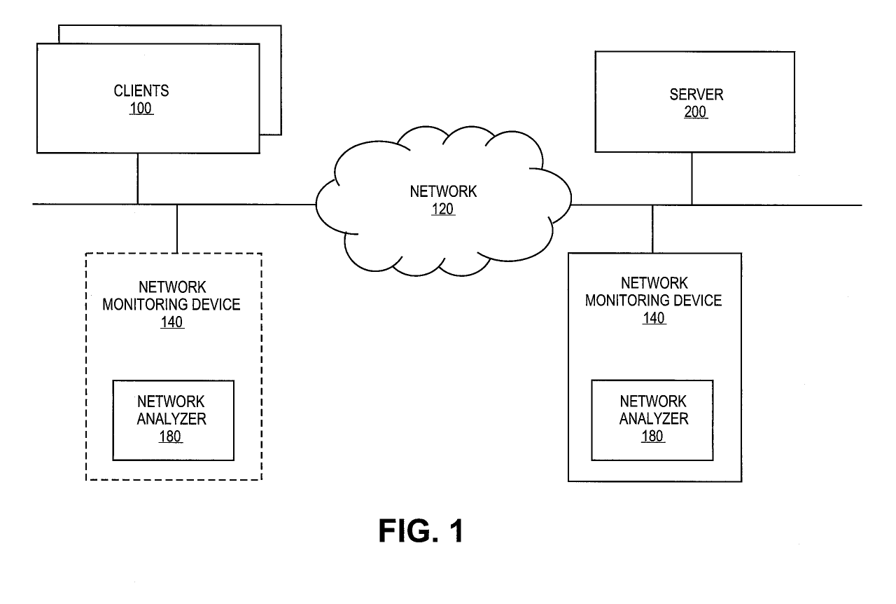

FIG. 1 is a block diagram of one embodiment of a network. Referring to FIG. 1, a network may comprise multiple network devices 100 which include clients and servers that communicate over a network 120 by sending and receiving network traffic. The traffic is sent as packets according to one or more protocols using one or more packet formats.

A network monitoring device 140 is also connected to the network to monitor traffic being sent on the network. Network monitoring device 140 may also perform analysis on the data collected using an analysis engine and a data memory.

In one embodiment, network monitoring device 140 comprises hardware and software, CPU, memory, and interfaces to connect to and monitor traffic on the network, as well as performing various testing and measurement operations, transmitting and receiving data, etc. In one embodiment, network monitoring device 140 operates as part of a computer or workstation interfaced with the network.

In one embodiment, packets are monitored as they are being transferred and internally the monitoring device attempts to identify the flow that each packet is part of and determine when the flow starts and stops. Network monitoring device 140 includes a mechanism to determine if the flow has ended or changed state, which includes tracking the state of the flow to determine if it is open or closed. Being able to determine whether a flow has been closed or changed state when data is missing that would explicitly specify such information is very useful. For example, this may be used for analysis and/or statistics. By performing such monitoring the analyzer can determine additional parameters such as whether memory resources and CPU resources are needed based on the state of the flow. That is, by having such information, the statistical information about the flow that is being stored and tracked may be processed and/or released for further analysis. Also, by knowing that a flow has been closed, the monitoring and analysis device is able to better allocate memory and resources.

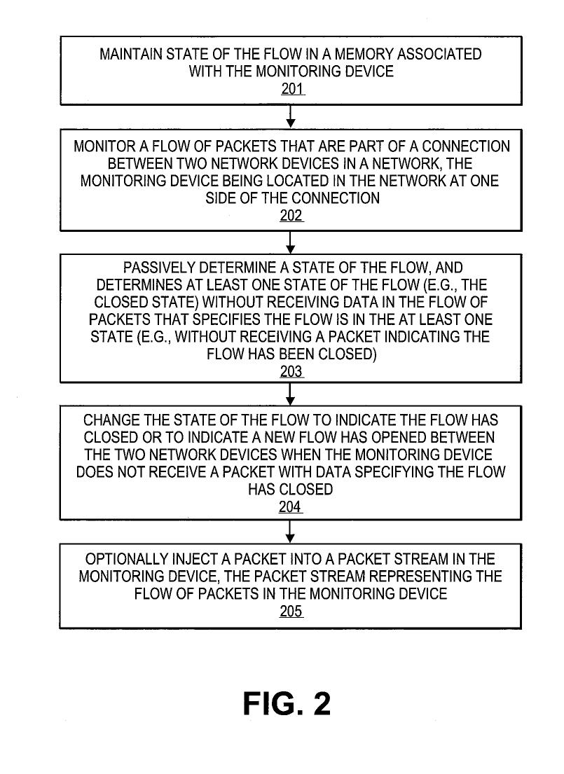

FIG. 2 is a flow diagram of a monitoring process performed by the network monitoring device. The process is performed by processing logic which may comprise hardware (e.g., circuitry, dedicated logic, etc.), software (such as is run on a general purpose computer system or a dedicated machine), or a combination of both. In one embodiment, the process is performed by a monitoring device such as described herein that tracks the state of each flow.

Referring to FIG. 2, the process begins by processing logic maintaining state of the flow in a memory associated with the monitoring device (processing block 201). In one embodiment, the flow is a Transmission Control Protocol (TCP) flow, and the state may be maintained in a memory (e.g., database) within the monitoring device or accessible by the monitoring device, such as over a network or dedicated connection.

Next, processing logic monitors a flow of packets that are part of a connection between two network devices in a network, where the monitoring device is located in the network at one side of the connection (processing block 202). Note that in another embodiment, the monitoring device monitors multiple distinct packet flows at the same time. Also, multiple monitoring devices may be used to monitor network traffic at both sides of the connection.

While monitoring the packet flow, processing logic passively determines a state of the flow, and determines at least one state of the flow (e.g., the closed state) without receiving data in the flow of packets that specifies the flow is in the at least one state (e.g., without receiving a packet indicating the flow has been closed) (processing block 203). In one embodiment, processing logic determines at least one state of the flow without receiving data in the flow of packets that specifies the flow is in the at least one state by determining the flow has been closed without receiving a packet in the flow with data that specifies the flow has been closed. In one embodiment, the data specifying the flow has been closed comprises data indicating destruction of the network connection. In another embodiment, the data specifying the flow has been closed comprises data indicating instantiation of a new network connection between the two network devices.

Upon determining the state of the flow, processing logic changes the state of the flow in the memory used to maintain the flow state to indicate the flow has closed or to indicate a new flow has opened between the two network devices when the monitoring device does not receive a packet with data specifying the flow has closed (processing block 204) and optionally injects a packet into a packet stream in the monitoring device, which represents the flow of packets in the monitoring device (processing block 205).

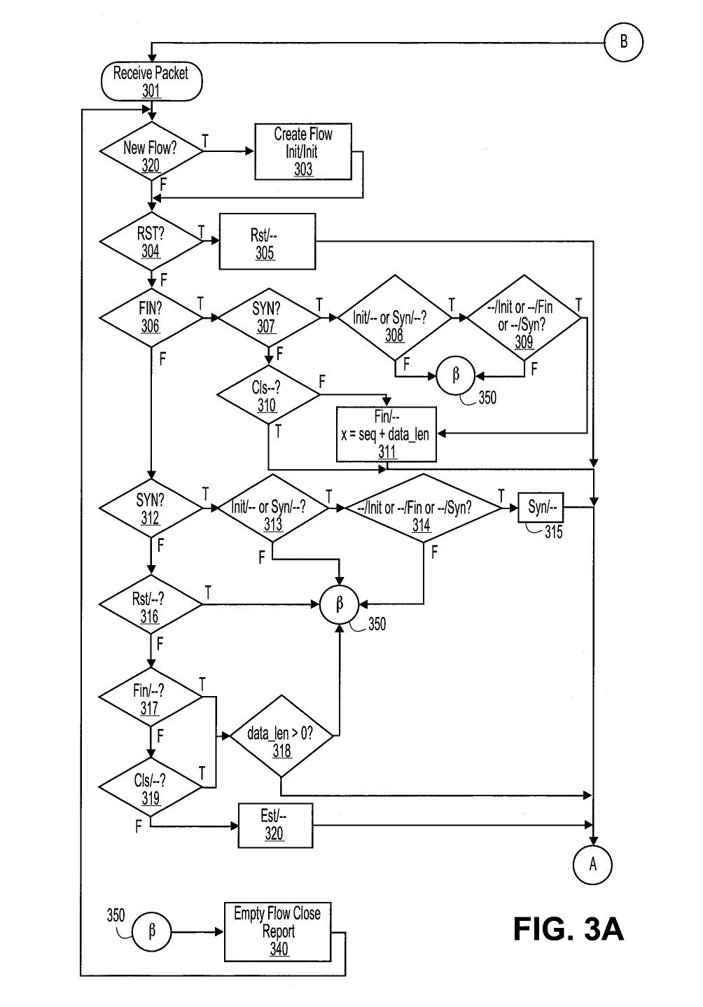

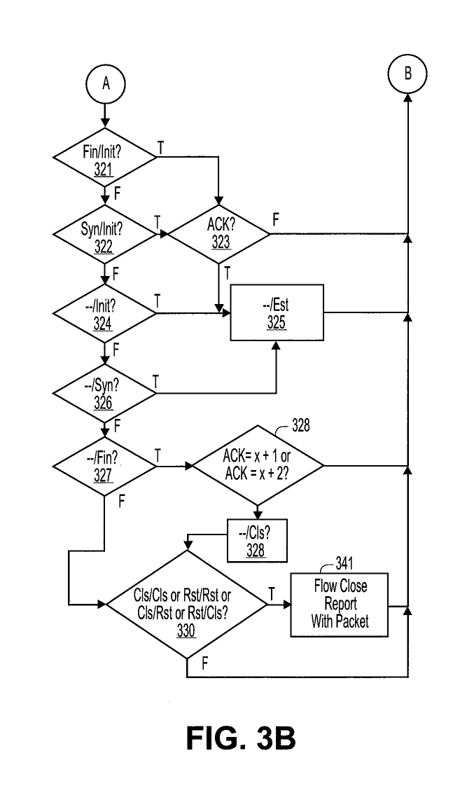

FIG. 3 is a more detailed flow diagram of a process for packet flow state determination performed as part of the monitoring process. The process is performed by processing logic which may comprise hardware (e.g., circuitry, dedicated logic, etc.), software (such as is run on a general purpose computer system or a dedicated machine), or a combination of both. In one embodiment, the process is performed by a network monitoring device such as described herein that tracks the state of each flow to determine if the flow has opened or closed.

The flow diagram of FIG. 3 uses a number of states that are described below and are used to internally identify the state of the connection for each side of the flow. That is, the states are used to track more detail about the flow in addition to the flags, which provides information to determine the state of the flow in the event of missing packets.
Initialization (Init)—No information about the connection state has been determined for this side of the flow.
Synchronization (Syn)—The corresponding side of the flow is in the process of making a connection, requires a SYN flag to be seen, but other state parameters are also checked (e.g., blocks 313, 314)
Finished (Fin)—The corresponding side of the flow is in the process of closing its connection, requires a FIN flag to be seen, but other state parameters are also checked (e.g., blocks 307-311)
Close (Cls)—The corresponding side of the flow has been disconnected through a FIN flag which was acknowledged by the receiver.
Reset (Rst)—The corresponding side of the flow has been disconnected through a RST flag. This does not require any feedback from the receiver.
Established (Est)—The corresponding side of the flow is connected and can transmit data. This can occur through a typical SYN, SYN-ACK, ACK sequence, but there are other points in the flow chart where it can be determined the connection must be open and the connection packets were missed (e.g., block 319, 320).

In one embodiment, each side of the flow is an independent connection. It is possible for one side of a flow to be closed and the other side to be established and sending data. When both sides of the flow are deemed to have ended, then the flow itself is closed. This can occur due to certain combinations of the states as in block 330 of FIG. 3 (described further below). Also, the flow can close due to certain combinations of states along with certain TCP flags as in block 350 of FIG. 3 (described further below).

Referring to FIG. 3, the process begins by processing logic receiving a packet (processing block 301). In one embodiment, as part of receiving the packet, processing logic computes a flow identifier (ID) associated with the packet to determine the flow of which they are a part. In one embodiment, the flow ID is computed by computing a hash over a portion of the header of each packet in a manner well-known in the art.

After receiving the packet, the processing logic determines whether the packet is associated with a new flow (processing block 302). This is performed by comparing the flow ID with those stored in the memory associated with the monitoring device. If it is, the process transitions to processing block 303 where the processing logic creates a new flow in memory. At this point, the state of the flow at the sender and receiver of the packet are both put into the initialization (Init) state, and thereafter, the process transitions to processing block 304. If processing logic determines that the received packet is not part of a new flow at processing block 302, the process transitions to processing block 304.

At processing block 304, processing logic tests whether the reset (RST) flag is set in the packet. If processing logic determines that the RST flag of the packet is set, the process transitions to processing block 305 where the monitoring device puts the state of the flow at the sender in the reset (Rst) state and does not change the state of the flow at the receiver state. (Note that the “--” in FIG. 3 indicates that there is no change in the state of the sender if on the left side of “/” and no change in the state of the flow at the receiver if the “--” is on the right side of the “/”.) After setting the flow state at the sender into the reset (Rst) state, processing logic transitions to processing block 321.

If processing logic determines that the RST flag in the packet is not set at processing block 304, the process transitions to processing block 306, where processing logic determines whether the FIN flag in the packet is set indicating that sender will not be transmitting any further TCP payload data. If it is set, processing logic transitions to processing block 307 where processing logic tests whether the synchronization (SYN) flag in the packet is set. If it is, processing logic transitions to processing block 308 where processing logic tests whether the flow state of the sender is in the initialization (Init) or synchronization (Syn) state. If it is, the process transitions to processing block 309 where processing logic tests whether the receiver is in the Init state indicating the receiver is starting a flow, the finished (Fin) state or the synchronization (Syn) state. If it is, processing logic transitions to processing block 311.

If processing logic determines that the flow state at the sender is not in the initialization (Init) or synchronization (Syn) states or determines that the flow state at the receiver is not in the initialization (Init), finished (Fin), or synchronization (Syn) states, processing logic transitions to processing block 350.

If processing logic determines that the SYN flag is not set at processing block 307, then the process transitions to processing block 310 where processing logic tests whether the flow state at the sender is in the close (Cls) state. If it is, processing logic transitions to processing block 321. If it is not, processing logic transitions to processing block 311.

At processing block 311, the flow state at the sender is put in the finished (Fin) state, and the variable x is set equal to the sum of the sequence number (seq) plus the length of the data (data_len). Thereafter, the processing logic transitions to processing block 321.

If processing logic determines that the FIN flag is not set at processing block 306, the process transitions to processing block 312 where processing logic determines if the SYN flag is set. If the SYN flag is not set, the processing logic transitions to processing block 316. If it is set, the process transitions to processing block 313 where processing logic checks whether the state of the flow at the sender is in the initialization (Init) or synchronization (Syn) states. If it is, the process transitions to processing block 314. If it is not, the process transitions to processing block 350. At processing block 314, processing logic determines whether the state of the flow at the receiver is in either the initialization (Init), finished (Fin), or synchronization (Syn) states. If it is not, the process transitions to processing block 350. If it is, the process transitions to processing block 315 where the state of the flow at the sender is put into the synchronization (Syn) state and the process transitions to processing block 321.

At processing block 316, processing logic determines whether the state of the flow at the sender is in the reset (Rst) state. If it is, the process transitions to processing block 350. If it is not, the process transitions to processing block 317.

At processing block 317, processing logic determines whether the state of the flow at the sender is in the finished (Fin) state. If it is, processing logic transitions to processing block 318. If it is not, the process transitions to processing block 319. At processing block 319, processing determines whether the flow state at the sender is in the close (Cis) state. If it is, the process transitions to processing block 318. If it is not, the process transitions to processing block 320.

At processing block 318, processing logic determines whether the length of the TCP payload data (data_len) (and not the size of the packet itself) is greater than zero. If it is, processing logic transitions to processing block 350. If it is not, processing logic transitions to processing block 321.

At processing block 320, the state of the flow at the sender is put into the established (Est) state in which the flow is then established. More specifically, for example, if a packet does not have any state changing flags (blocks 304, 306, 312) and the sender is not in a flow ending state (blocks 316, 317, 319), it can be assumed that the sender has an established connection. Thereafter, the process transitions to processing block 321.

At processing block 350, processing logic generates an empty flow close report (processing block 340). The empty flow close report is information that indicates the flow has closed. This in essence injects state into the packet stream of the monitoring device that indicates that the flow has closed. Thus, when the empty flow is closed occurs, the monitoring device sends a notification that the flow closed. However, there is no packet associated with it and the next packet is pushed in after that notification. Thereafter, the process transitions to processing block 302.

At processing block 321, processing logic tests whether the state of the flow at the sender is in the finished (Fin) state and the state of the flow at the sender is in the initialization (Init) state. If it is, the process transitions to processing block 323 where processing logic tests whether an acknowledgement (ACK) flag for the packet has been set. If not, the process transitions to processing block 301 and the process repeats for the next packet. If so, the process transitions to processing block 325. If the state of the flow at the sender is not in the finished (Fin) state and the state of the flow at the receiver is not in the initialization (Init) state at processing block 321, processing logic transitions to processing block 322 where processing logic tests whether the state of the flow at the receiver is in the synchronization (Syn) state and the state of the flow at the receiver is at the initialization (Init) state. If it is, processing logic transitions to processing block 323. If not, processing logic transitions to processing block 324 where processing logic tests whether the state of the flow at the receiver is in the initialization (Init) state. If it is, processing logic transitions to processing block 325.

At processing block 325, processing logic sets the receiver in the established state and then transitions to processing block 301 to repeat the process for the next packet.

If processing logic determines at processing block 324 that the receiver is not in the initialization (Init) state, the processing logic transitions to processing block 326 where the processing block tests whether the flow state at the receiver is in the synchronization (Syn) state. If it is, processing logic transitions to processing block 325. If it is not, the processing logic transitions to processing block 327 where processing logic tests whether the flow state at the receiver is in the finished (Fin) state. If it is not, the processing logic transitions to processing block 330. If it is, the processing logic transitions to processing block 328 where the processing logic tests whether the packet received is an acknowledgment to a previously seen packet that had the FIN flag set. That is, in the case of the transition from processing block 328, the monitoring device wants to examine the current packet to see if it is acknowledging a previously seen packet that had the FIN flag set. Therefore, using the TCP acknowledgement number that is in the current packet, the monitoring device can look to see if the current packet acknowledges a previously seen packet that had the FIN flag set where the processing block 311 had stored the TCP sequence of the previously seen packet that had the FIN flag set (stored as variable x) in the flow state for that flow. Note that the processing logic accounts for both the FIN flag set in the previously seen packet as well as the FIN and SYN flags set in the previously seen packet as indicated in processing block 328 by checking for x+1 and also for x+2. It is also possible and evident to those skilled in the art that this particular logic can be modified and yet maintain the intent of the invention such that processing block 328 can make the determination which it is intended to make. If it has not received the acknowledgement, the process transitions to processing block 301 and the process repeats for the next packet. If it has received the acknowledgement, the process transitions to processing block 329 where processing logic sets the state of the receiver to the close (Cis) state and transitions processing to block 330.

At processing block 330, processing logic tests whether the state of the flow at the sender and the receiver is both close (Cis), both reset (Rst), is close (Cis) at the sender and reset (Rst) at the receiver, or reset (Rst) at the sender and close (Cls) at the receiver. If not, the process transitions to processing block 301 to repeat the process for the next packet. If it is, the process transitions to processing block 341 and the current packet is augmented with a flow close report which provides the monitoring device with an indication that the flow has been closed, and the process transitions to processing block 301 to repeat the process for the next packet. Note that processing block 340 injects both state and a packet into the internal packet stream of the monitoring device while processing block 341 is only required to inject or augment the current packet with the flow close report (or state attached to the packet indicating that the packet is the last packet in the flow of which it is part). Processing block 341 could optionally inject both state and a packet into the internal packet stream of the monitoring device rather than augmenting the current packet so long as it injected the packet immediately following the current packet and not before the current packet. In either case, when the flow close report is analyzed by the monitoring device, the packet signals the end of the flow.

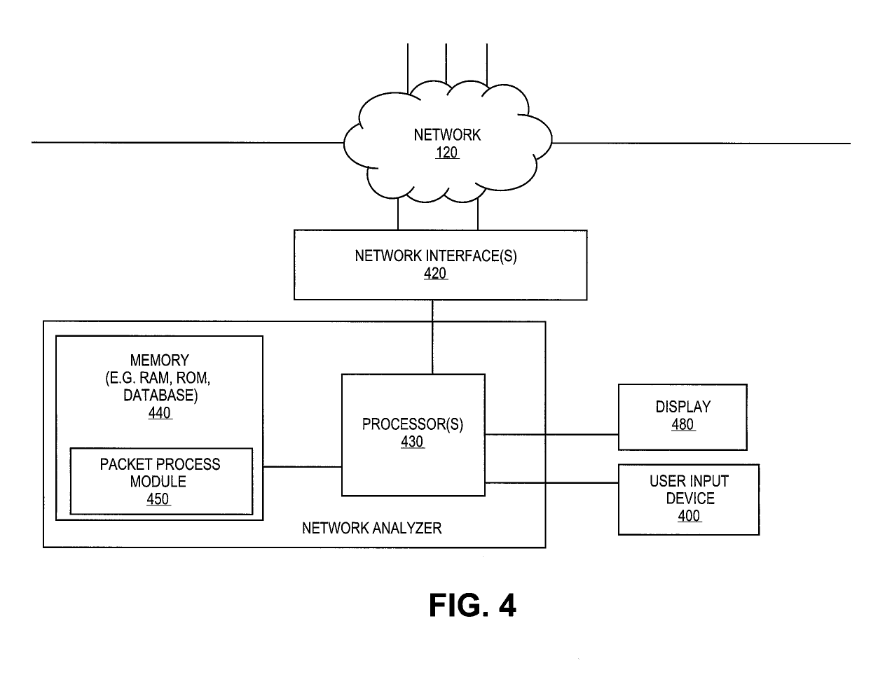

FIG. 4 is one embodiment of a block diagram of a network monitoring device, wherein the instrument may include network interfaces 422 which attach the device to a network via multiple ports, one or more processors 423 for performing the monitoring and analysis, memory (e.g., RAM, ROM, databases, etc.) 424, display 428, user input devices 430 (e.g., keyboard, mouse or other pointing devices, touch screen, etc.). Packet processing module 425 is stored in memory 424 and may be executed by processors 423 provides processing of packets and storage of data related thereto for use in the monitoring device to assist in the flow processing and analysis related to client/server traffic.

In operation, the monitoring device is attached to the network, and observes transmissions on the network to collect information and statistics thereon related to client/server traffic. The network monitoring device uses a set of filters that operate based on IP addresses and/or ports to select traffic that is within those IP ranges and/or port ranges in order to collect only information that is relevant to client/server traffic. Such IP address ranges or ports may be set by the network monitoring device using a user interface.

If the traffic is within the server group of interest, then the traffic data or information about the traffic is passed on for further storage, processing, analysis, etc., to ultimately provide information to a user regarding desired client/server traffic.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention. The process is performed by processing logic that may comprise hardware (circuitry, dedicated logic, etc.), software (such as is run on a general purpose computer system or a dedicated machine), or a combination of both.

We claim:

1. A method comprising:
monitoring, using a monitoring device, a flow of packets that are part of a connection between two network devices in a network, the monitoring device being located in the network at one side of the connection; and
passively determining a state of the flow while monitoring the flow, including determining at least one state of the flow without receiving data in the flow of packets that specifies the flow is in the at least one state.

2. The method defined in claim 1 wherein determining at least one state of the flow without receiving data in the flow of packets that specifies the flow is in the at least one state comprises determining the flow has been closed without receiving a packet in the flow with data that specifies the flow has been closed.

3. The method defined in claim 2 wherein the data specifies the flow has been closed comprises data indicating destruction of the network connection.

4. The method defined in claim 2 wherein the data specifies the flow has been closed comprises data indicating instantiation of a new network connection between the two network devices.

5. The method defined in claim 1 further comprising:
maintaining state of the flow in a memory associated with the monitoring device; and
changing the state of the flow to indicate the flow has closed when the monitoring device does not receive a packet with data specifying the flow has closed.

6. The method defined in claim 1 further comprising injecting a packet into a packet stream in the monitoring device, the packet stream representing the flow of packets in the monitoring device.

7. The method defined in claim 1 further comprising:
maintaining state of the flow in a memory associated with the monitoring device; and
changing the state of the flow to indicate a new flow has opened between the two network devices when the monitoring device does not receive a packet in the flow with data specifying the flow has closed.

8. The method defined in claim 1 wherein the flow comprises a Transmission Control Protocol (TCP) flow.

9. An article of manufacture having one or more computer readable storage media storing instructions which, when executed by a monitoring device in a network, cause the device to perform a method comprising:
monitoring a flow of packets that are part of a connection between two network devices in a network, the monitoring device being located in the network at one side of the connection; and
passively determining a state of the flow while monitoring the flow, including determining at least one state of the flow without receiving data in the flow of packets that specifies the flow is in the at least one state.

10. The article of manufacture defined in claim 9 wherein determining at least one state of the flow without receiving data in the flow of packets that specifies the flow is in the at least one state comprises determining the flow has been closed without receiving a packet in the flow with data that specifies the flow has been closed.

11. The article of manufacture defined in claim 9 wherein the method further comprises:
maintaining state of the flow in a memory associated with the monitoring device; and
changing the state of the flow to indicate the flow has closed when the monitoring device does not receive a packet with data specifying the flow has closed.

12. The article of manufacture defined in claim 9 wherein the method further comprises injecting a packet into a packet stream in the monitoring device, the packet stream representing the flow of packets in the monitoring device.

13. The article of manufacture defined in claim 9 wherein the method further comprises:
maintaining state of the flow in a memory associated with the monitoring device; and
changing the state of the flow to indicate a new flow has opened between the two network devices when the monitoring device does not receive a packet in the flow with data specifying the flow has closed.

14. A monitoring device for use in a network having at least two network devices, the monitoring device comprising:
a network interface for coupling to the network;
a memory; and
an analyzer coupled to the network interface and the memory to monitor a flow of packets that are part of a connection between two network devices in the network from a location in the network at one side of the connection and to passively determine a state of the flow while monitoring the flow, the analyzer being operable to determine at least one state of the flow without receiving data in the flow of packets that specifies the flow is in the at least one state.

15. The device defined in claim 14 wherein the analyzer determines at least one state of the flow without receiving data in the flow of packets that specifies the flow is in the at least one state comprises determining the flow has been closed without receiving a packet in the flow with data that specifies the flow has been closed.

16. The device defined in claim 15 wherein the data specifies the flow has been closed comprises data indicating destruction of the network connection.

17. The device defined in claim 15 wherein the data specifies the flow has been closed comprises data indicating instantiation of a new network connection between the two network devices.

18. The device defined in claim 14 wherein the analyzer is operable to:
maintain state of the flow in a memory associated with the monitoring device; and
change the state of the flow to indicate the flow has closed when the monitoring device does not receive a packet with data specifying the flow has closed.

19. The device defined in claim 14 wherein the analyzer is operable to inject a packet into a packet stream in the monitoring device, the packet stream representing the flow of packets in the monitoring device.

20. The device defined in claim 14 wherein the analyzer is operable to:
maintain state of the flow in a memory associated with the monitoring device; and
change the state of the flow to indicate a new flow has opened between the two network devices when the monitoring device does not receive a packet in the flow with data specifying the flow has closed.
